(19) United States
(12) Patent Application Publication
(10) Pub. No.: US 2014/0181284 A1
(43) Pub. Date: Jun. 26, 2014

(54) TABLET COMPUTER SET AND METHOD FOR SHARING ITEMS

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/096,028

(22) Filed: Dec. 4, 2013

(30) Foreign Application Priority Data
Dec. 24, 2012 (CN) 201210565132X

(51) Int. Cl. G06F 3/041

(52) U.S. Cl. CPC G06F 3/041
USPC 709/223

(57) ABSTRACT

A tablet computer set comprises a main tablet device having a main display screen and at least a sub display device having a sub display screen. The main tablet device includes an input unit, a communication unit and a processor. The input unit selects an item displayed on the main display screen and generates a sharing signal in response to an operation. The processor controls the communication unit to transfer the selected item to the sub display device in response to the sharing signal. The sub display device includes a communication module and a sub processor. The communication module receives the selected item and the sharing signal transferred from the main tablet device. The sub processor controls the sub display screen to display the selected item once received the sharing signal.

A method for sharing items is also provided by the present disclosure.

### BACKGROUND

1. Technical Field

The present disclosure relates to tablet computer set and method for sharing items between tablet computers of the tablet computer set.

2. Description of Related Art

A tablet computer is equipped having a display screen and the size of the tablet computer is generally small for easy carrying. However, when two or more users gather together to enjoy a file or a video displayed on the screen, it is not convenient and comfortable for these users with such a small size screen.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a tablet computer in accordance to an exemplary embodiment of the present disclosure.

FIG. 2 is a block view of the tablet computer in FIG. 1.

FIG. 3 is a flowchart of a method for sharing items, in accordance to an exemplary embodiment of the present disclosure.

### DETAILED DESCRIPTION

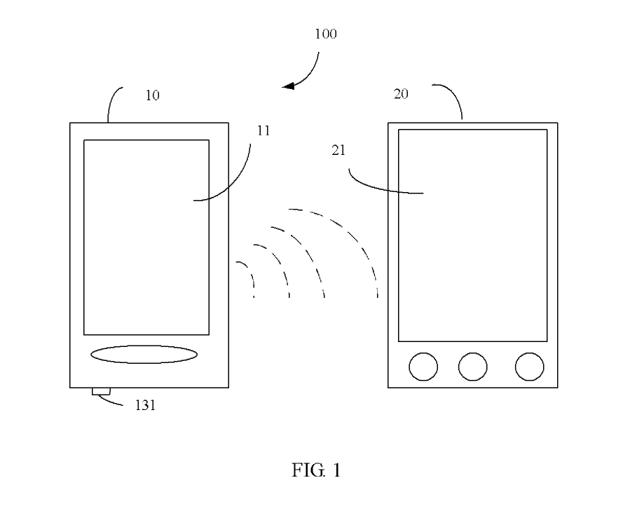

FIG. 1 shows a tablet computer set 100 in accordance to an exemplary embodiment of the present disclosure. The tablet computer set 100 includes a main tablet device 10 having a main display screen 11 and a sub display device 20 having a sub display screen 21. The sub display device 20 communicates having the main tablet device 10. In the embodiment, the sub display device 20 communicates with the main tablet device 10 by wireless signal such as Bluetooth or WIFI.

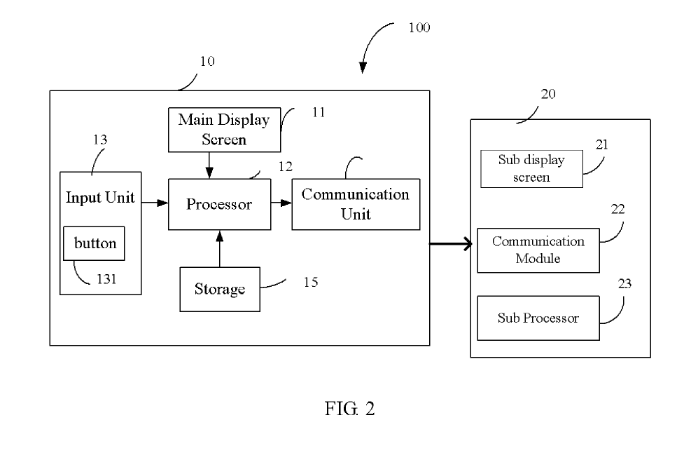

FIG. 2 shows that the main tablet device 10 includes a processor 12, an input unit 13 and a communication unit 14.

The input unit 13 is configured to allow a user to select an item displayed on the display screen 11 and generate a sharing signal in response to the user's selection. The processor 12 controls the communication unit 14 to transfer the sharing signal and the selected item to the sub display device 20 in response to the sharing signal. In the embodiment, the input unit 13 includes a button 131 mounted at the bottom of a shell of the main tablet device 10. When user presses the button 131, the item currently displayed on the main display screen 11 is transmitted to the sub display device 20 and further synchronously displayed on the sub display screen 21 of the sub display device 20.

In an alternative embodiment, the main tablet device 10 further includes a storage 15. The storage 15 stores items to be displayed on the main display screen and shared with the sub display device 20, such as text files, picture files, video files or music files.

The sub display device 20 includes a communication module 22 and a sub processor 23. The communication module 22 is configured to communicate with the communication unit 14 to receive the sharing signal and the sharing item transferred from the main tablet device 10. The sub processor 23 is configured to control the sub display screen 21 to timely display the sharing item received by the communication module 22 according to the received the sharing signal, thus the item displayed on the main display screen 11 of the tablet device 10 is synchronously displayed on the sub display screen 21 of the sub display device 20.

The tablet computer set provided by the present disclosure includes a main tablet device having a main display screen and a sub display device having a sub display. The main tablet device communicates with the sub display device and controls to synchronously display sharing items on the sub display screen. Therefore, it is more convenient and comfortable for users who gather together to share information of the main tablet device.

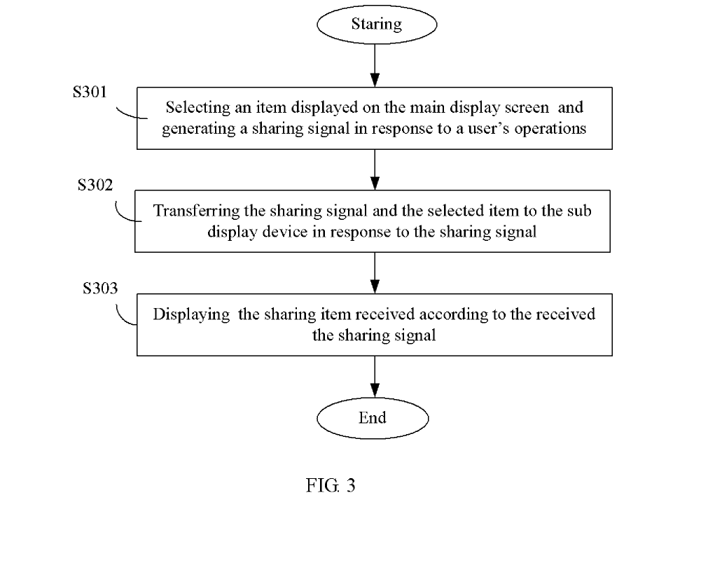

FIG. 3 shows a flowchart of a method for sharing items. The method applied to the tablet computer set 100 including the main tablet device 10 having the main display screen 11 and the sub display device 20 having the sub display screen 21. The method includes following steps:

In step S301, the input unit 13 allows a user to select an item displayed on the main display screen 11 and generates a sharing signal in response to a user's selection.

In the embodiment, the input unit 13 includes a button 131 mounted at the bottom of a shell of the main tablet device 10. When the button 131 is operated, the sharing signal is generated.

In step S302, the processor 12 controls the communication unit 14 to transfer the sharing signal and the selected item to the sub display device 20 in response to the sharing signal.

The communication module 22 communicates with the communication unit 14 and receives the sharing signal and the sharing item transferred from the main tablet device 10.

The sub processor 23 controls the sub display screen 21 to automatically and timely display the sharing item received according to the received the sharing signal.

In the embodiment, the sharing item displayed on the sub display screen 21 is synchronously displayed on the main display screen of the tablet device.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A tablet computer set, comprising:
a main tablet device having a main display screen; and
a sub display device having a sub display screen, communicating with the main tablet device; wherein
the main tablet device comprises:
an input unit configured to allow a user to select an item displayed on the main display screen and generate a sharing signal in response to the user's selection;
a communication unit;
a processor configured to control the communication unit to transfer the sharing signal to the sub display device and the selected item to the sub display device; and
the sub display screen comprises:
a communication module configured to communicate with the communication unit to receive the sharing signal and the selected item transmitted from the main tablet device;
a sub processor configured to control the sub display device to display the received selected item on the sub display screen according to the sharing signal received by the communication module.

2. The tablet computer set as described in claim 1, wherein the main tablet device comprises a storage to store items to be displayed on the display screens.

3. The tablet computer set as described in claim 2, wherein the communication unit wirelessly communicates with the communication module.

4. The tablet computer set as described in claim 3, wherein the communication unit communicates with the communication module through WIFI.

5. The tablet computer set as described in claim 3, wherein the communication unit communicates with the communication module through Bluetooth.

6. The tablet computer set as described in claim 2, wherein the item is selected from the group consisting of a text file, a picture file, a video file and a music file.

7. The tablet computer set as described in claim 1, wherein the main tablet device further comprises a button mounted on the main tablet device.

8. The tablet computer set as described in claim 1, wherein the button generates a sharing signal when the button is operated.

9. A method for sharing items between tablet set of a tablet computer set, the method comprising:
displaying items on a main display screen of a main tablet device;
generating a sharing signal in response to a user's selection of one of the items displayed on the main tablet device;
transferring the sharing signal and the selected items to a sub display device; and
displaying the selected items on a sub display screen of the sub display device in response to the sharing signal.

10. The method as described in claim 8, wherein the user's selection is depressing operation on a button of the main tablet device.

11. The method as described in claim 8, wherein the selected items displayed on the main display screen of the main display device is synchronously displayed on the sub display screen of the sub tablet device.
